(19) United States
(12) Patent Application Publication
(10) Pub. No.: US 2026/0107005 A1
(43) Pub. Date: Apr. 16, 2026

(54) MESH DECODING DEVICE, MESH DECODING METHOD, AND PROGRAM

(71) Applicant: KDDI CORPORATION, Tokyo (JP)

(72) Inventors: Hitoshi NISHIMURA, Fujimino-shi (JP); Kei KAWAMURA, Fujimino-shi (JP)

(73) Assignee: KDDI CORPORATION, Tokyo (JP)

(21) Appl. No.: 19/419,149

(22) Filed: Dec. 15, 2025

Related U.S. Application Data
(63) Continuation of application No. PCT/JP2024/007924, filed on Mar. 3, 2024.

(30) Foreign Application Priority Data
Jul. 3, 2023 (JP) 2023-109440

(51) Int. Cl. H04N 19/44; G06T 9/00; H04N 19/60

(52) U.S. Cl. CPC H04N 19/44; G06T 9/001; H04N 19/60

(57) ABSTRACT

A displacement decoding unit (205) of a mesh decoding device (200) according to the present invention includes: an arithmetic decoding unit (205A) that generates a coefficient level value by performing arithmetic decoding on a displacement bit stream; a context value update unit (205B) that updates a context value using the coefficient level value; a context value buffer (205C) that acquires and accumulates the context value; an arithmetic decoding initialization unit (205D) that initializes the context value for each frame; an inverse quantization unit (205E) that generates a transform coefficient by performing inverse quantization on the coefficient level value; and an inverse transform unit (205F) that generates a decoded displacement by performing inverse transform on the transform coefficient.

### CROSS-REFERENCE TO RELATED APPLICATIONS

The present application is a continuation of PCT Application No. PCT/JP2024/007924, filed on March 3, 2024, which claims the benefit of Japanese patent application No. 2023-109440 filed on July 3, 2023, the entire contents of each application being incorporated herein by reference in its entirety.

### TECHNICAL FIELD

The present invention relates to a mesh decoding device, a mesh decoding method, and a program.

### BACKGROUND ART

Non Patent Literature 1(Khaled Mammou, Jungsun Kim, Alexis Tourapis, Dimitri Podborski, Krasimir Kolarov, “[V-CG] Apple's Dynamic Mesh Coding CfP Response,” ISO/IEC JTC 1/SC 29/WG 7 m5928, April 2022) discloses a technique of decoding a mesh by dividing the mesh into a rough base mesh and a detailed displacement, transforming the displacement to a two-dimensional video, and then performing decoding by a video codec.

### SUMMARY OF THE INVENTION

However, in the technology disclosed in Non Patent Literature 1, a generated two-dimensional video is not suitable for encoding by a video codec, and there is a problem that encoding efficiency is lowered. Therefore, the present invention has been made in view of the above-described problems, and an object thereof is to provide a mesh decoding device, a mesh decoding method, and a program capable of improving encoding efficiency.

A first feature of the present invention is summarized as a mesh decoding device including: a displacement decoding unit configured to decode a displacement bit stream to generate and output a displacement, wherein the displacement decoding unit includes: an arithmetic decoding unit configured to generate a coefficient level value by performing arithmetic decoding on the displacement bit stream; a context value update unit configured to update a context value using the coefficient level value; a context value buffer configured to acquire and accumulate the context value; an arithmetic decoding initialization unit configured to initialize the context value for each frame; an inverse quantization unit configured to generate a transform coefficient by performing inverse quantization on the coefficient level value; and an inverse transform unit configured to generate a decoded displacement by performing inverse transform on the transform coefficient.

A second feature of the present invention is summarized as a mesh decoding method, including: a step of decoding a displacement bit stream to generate and output a displacement, wherein the step includes: a step A of generating a coefficient level value by performing arithmetic decoding on the displacement bit stream; a step B of updating a context value using the coefficient level value; a step C of acquiring and accumulating the context value; a step D of initializing the context value for each frame; a step E of generating a transform coefficient by performing inverse quantization on the coefficient level value; and a step F of generating a decoded displacement by performing the inverse transform on the transform coefficient.

A third feature of the present invention is summarized as a non-transitory computer-readable medium having stored thereon a program that is executable by a computer to cause the computer to function as a mesh decoding device, the mesh decoding device including a displacement decoding unit configured to decode a displacement bit stream to generate and output a displacement, wherein the displacement decoding unit includes: an arithmetic decoding unit configured to generate a coefficient level value by performing arithmetic decoding on the displacement bit stream; a context value update unit configured to update a context value using the coefficient level value; a context value buffer configured to acquire and accumulate the context value; an arithmetic decoding initialization unit configured to initialize the context value for each frame; an inverse quantization unit configured to generate a transform coefficient by performing inverse quantization on the coefficient level value; and an inverse transform unit configured to generate a decoded displacement by performing inverse transform on the transform coefficient.

According to the present invention, it is possible to provide a mesh decoding device, a mesh decoding method, and a program capable of improving encoding efficiency.

### BRIEF DESCRIPTION OF THE DRAWINGS

FIG. 1 is a diagram illustrating an example of a configuration of a mesh processing system 1 according to an embodiment. FIG. 2 is a diagram illustrating an example of functional blocks of a mesh decoding device 200 according to an embodiment. FIG. 3 is a diagram illustrating an example of functional blocks of a displacement decoding unit 205 of the mesh decoding device 200 according to an embodiment. FIG. 4 is a diagram illustrating an example of a configuration of a displacement bit stream. FIG. 5 is a flowchart illustrating an example of an operation of the displacement decoding unit 205 of the mesh decoding device 200 according to an embodiment.

### DESCRIPTION OF EMBODIMENTS

Hereinafter, embodiments of the present invention will be described with reference to the drawings. Note that components in the following embodiments can be replaced with existing components or the like as appropriate, and various variations including combinations with other existing components are possible. Therefore, the following description of the embodiments does not limit the contents of the invention described in the claims.

### First Embodiment

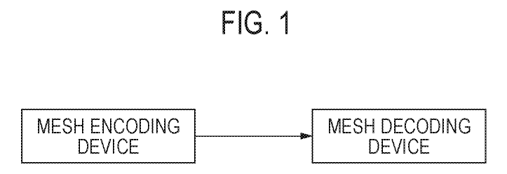

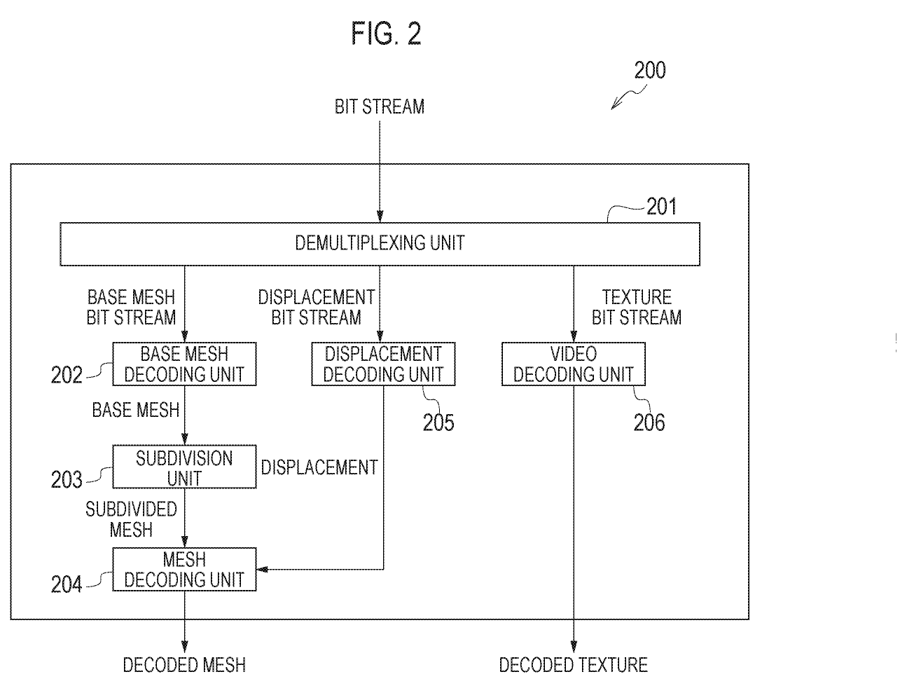

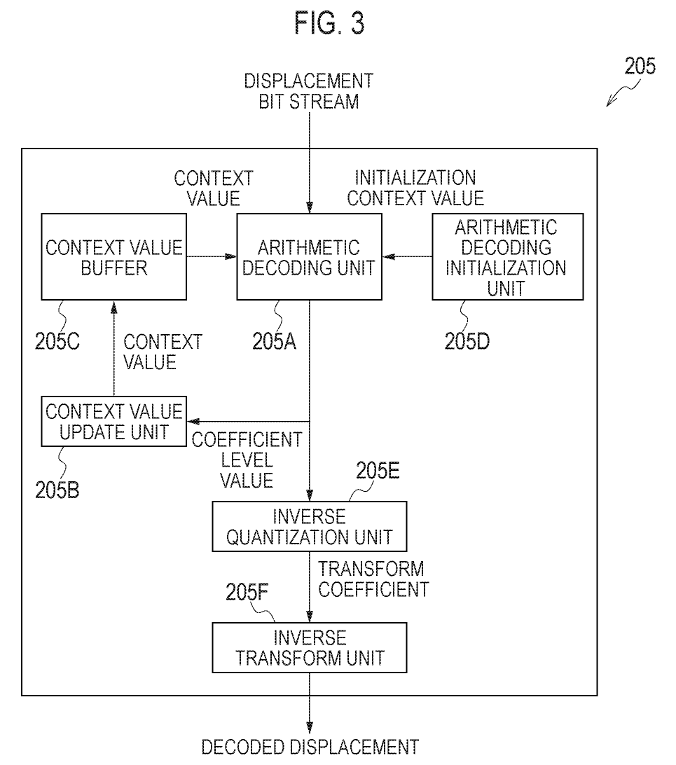

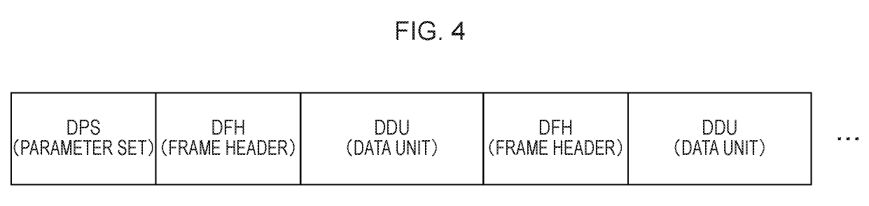

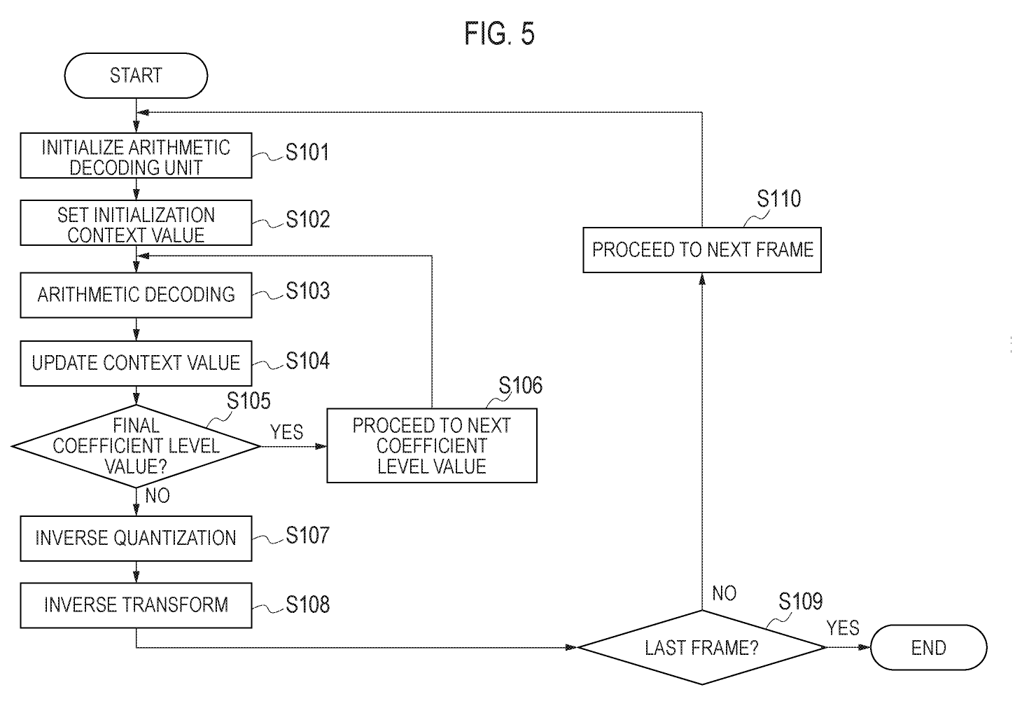

Hereinafter, a mesh processing system according to the present embodiment will be described with reference to FIGS. 1 to 5.

FIG. 1 is a diagram illustrating an example of a configuration of the mesh processing system 1 according to the present embodiment. As illustrated in FIG. 1, the mesh processing system 1 includes a mesh encoding device 100 and a mesh decoding device 200.

FIG. 2 is a diagram illustrating an example of functional blocks of the mesh decoding device 200 according to the present embodiment.

As illustrated in FIG. 2, the mesh decoding device 200 includes a demultiplexing unit 201, a base mesh decoding unit 202, a subdivision unit 203, a mesh decoding unit 204, a displacement decoding unit 205, and a video decoding unit 206.

A demultiplexing unit 201 is configured to separate the multiplexed bit stream into a base mesh bit stream, a displacement bit stream, and a texture bit stream.

A base mesh decoding unit 202 is configured to decode a base mesh bit stream, and generate and output a base mesh.

A subdivision unit 203 is configured to generate and output the added subdivision vertices and their connectivity information from the base mesh decoded by the base mesh decoding unit 202 by a subdivision method indicated by the control information.

Here, the base mesh, the added subdivision vertex, and the connectivity information thereof are collectively referred to as a “subdivision mesh”.

The mesh decoding unit 204 is configured to generate and output a decoded mesh by using the subdivision mesh generated by the subdivision unit 203 and the displacement decoded by the displacement decoding unit 205.

The displacement decoding unit 205 is configured to decode a displacement bit stream to generate and output a displacement.

The video decoding unit 206 is configured to decode and output texture by video coding. For example, the video decoding unit 206 may use HEVC described in Non Patent Literature 1.

### Displacement Decoding Unit 205

FIG. 3 is a functional block diagram illustrating an example of a configuration of displacement decoding unit 205. As illustrated in FIG. 3, the displacement decoding unit 205 includes an arithmetic decoding unit 205A, a context value update unit 205B, a context value buffer 205C, an arithmetic decoding initialization unit 205D, an inverse quantization unit 205E, and an inverse transform unit 205F.

The arithmetic decoding unit 205A is configured to generate and output a coefficient level value by performing arithmetic decoding on the received displacement bit stream.

The coefficient level values generated by the arithmetic decoding unit 205A are represented by a 3×N size matrix in each frame. Here, 3 represents the number of dimensions, and N represents the total number of subdivision vertices. A subdivision level is defined for each subdivision vertex.

The arithmetic decoding unit 205A may directly generate the coefficient level value. Alternatively, the arithmetic decoding unit 205A may efficiently generate the coefficient level value using a plurality of syntaxes such as a flag (sig_coeff_flag) indicating whether a coefficient level value described later is significant.

The arithmetic decoding unit 205A decodes the original value according to which section on the number line the input binary decimal number is included.

The arithmetic decoding unit 205A defines a number line from 0 to 1, divides the section by a binary occurrence probability (hereinafter, referred to as a context value), and uses the section.

The arithmetic decoding unit 205A may arithmetically decode the coefficient level values using a plurality of types of context values. For example, the arithmetic decoding unit 205A may divide and define the context value for each subdivision level, may divide and define the context value for each dimension, or may divide and define the context value for each syntax.

Furthermore, the arithmetic decoding unit 205A may define the context value by dividing the coefficient level value for each sub-mesh that is a unit that can be processed in parallel.

Furthermore, the arithmetic decoding unit 205A may bypass updating of the context value by constantly fixing the context value to 0.5.

The arithmetic decoding unit 205A may set whether or not to bypass updating of the context value for each syntax. Note that, as described above, the arithmetic decoding unit 205A may generate the coefficient level value based on binary arithmetic decoding, or may generate the coefficient level value based on multi-valued arithmetic decoding such as RangeCoder.

The context value update unit 205B is configured to update the context value using the coefficient level value.

The context value update unit 205B updates the context value each time each coefficient level value is decoded. The context value update unit may use an update table in which the context value is slightly updated when a symbol having a high occurrence probability among 0 and 1 is generated, and the context value is largely updated when a symbol having a low occurrence probability is generated.

The context value buffer 205C is configured to acquire and accumulate the context value.

The arithmetic decoding initialization unit 205D is configured to initialize the context value for each frame. According to such a configuration, by initializing the context value for each frame, arithmetic decoding can be performed without using information of other frames, and random access can be realized. Here, the initialization context value may be, for example, 0.5.

Furthermore, the arithmetic decoding initialization unit 205D may divide the coefficient level value for each sub-mesh that is a unit that can be processed in parallel to initialize the context value.

Furthermore, the arithmetic decoding initialization unit 205D may omit initialization of the context value for syntax that bypasses updating of the context value.

The inverse quantization unit 205E is configured to generate and output a transform coefficient by performing inverse quantization on the received coefficient level value.

The inverse transform unit 205F is configured to generate and output a decoded displacement by performing inverse transform on the received transform coefficient. For the inverse transform, the inverse transform unit 205F may use, for example, inverse DCT or inverse wavelet transform.

### Configuration of Displacement Bit Stream

Hereinafter, an example of a configuration of the displacement bit stream will be described with reference to FIG. 4. FIG. 4 is a diagram illustrating an example of the configuration of the displacement bit stream.

As illustrated in FIG. 4, first, the displacement bit stream may include a displacement parameter set (DPS) that is a set of control information related to decoding of the displacement.

Second, the displacement bit stream may include a displacement frame header (DFH) that is a set of control information corresponding to the frame.

Third, the displacement bit stream may include a displacement data unit (DDU), which is an encoded displacement corresponding to the frame, next to the DFH.

The DDU may include a flag (sig_coeff_flag) indicating whether the coefficient level value is significant, a flag (coeff_abs_level_greater1_flag) indicating whether an absolute value of the coefficient level value is greater than or equal to 2, a flag (coeff_sign _flag) indicating a positive or negative sign of the coefficient level value, and the absolute value (coeff_abs_level_remaining) of the coefficient level value. Hereinafter, an example of an operation of displacement decoding unit 205 will be described with reference to FIG. 5. FIG. 5 is a flowchart illustrating an example of the operation of displacement decoding unit 205.

### Operation of Displacement Decoding Unit 205

Here, in the arithmetic decoding unit 205A, in a case where the context value is defined by dividing the coefficient level value for each sub-mesh that is a unit that can be processed in parallel, the operation of FIG. 5 is performed in parallel by the number of sub-meshes.

In Step S101, the arithmetic decoding initialization unit 205D initializes the arithmetic decoding unit 205A.

In Step S102, the arithmetic decoding initialization unit 205D initializes the context value for each frame.

In Step S103, the arithmetic decoding unit 205A generates the coefficient level value by performing arithmetic decoding.

In Step S104, the context value update unit 205B updates the context value.

In Step S105, the arithmetic decoding unit 205A determines whether the coefficient level value currently being processed is final. In the case of Yes, the operation proceeds to Step S106, and in the case of No, the operation proceeds to Step S107.

In Step S106, the arithmetic decoding unit 205A proceeds to the processing of the next coefficient level value.

In Step S107, the inverse quantization unit 205E generates the transform coefficient by performing inverse quantization.

In Step S108, the inverse transform unit 205F generates the decoding displacement by performing the inverse transform.

In Step S109, the arithmetic decoding unit 205A determines whether the currently processed frame is the last frame. In a case of Yes, the present operation ends, and in a case of No, the present operation proceeds to Step S110.

In Step S110, the arithmetic decoding unit 205A proceeds to the processing of the next frame.

According to the present embodiment, by initializing the context value for each frame, the arithmetic decoding can be performed without using information of other frames, and random access can be realized.

What is claimed is:

1. A mesh decoding device comprising:
a displacement decoding unit configured to decode a displacement bit stream to generate and output a displacement, wherein
the displacement decoding unit includes:
an arithmetic decoding unit configured to generate a coefficient level value by performing arithmetic decoding on the displacement bit stream;
a context value update unit configured to update a context value using the coefficient level value;
a context value buffer configured to acquire and accumulate the context value;
an arithmetic decoding initialization unit configured to initialize the context value for each frame;
an inverse quantization unit configured to generate a transform coefficient by performing inverse quantization on the coefficient level value; and
an inverse transform unit configured to generate a decoded displacement by performing inverse transform on the transform coefficient.

2. The mesh decoding device according to claim 1, wherein
the arithmetic decoding unit is configured to define the context value by dividing the coefficient level value for each sub-mesh that is a unit that can be processed in parallel.

3. The mesh decoding device according to claim 2, wherein
the arithmetic decoding initialization unit is configured to initialize the context value by dividing the coefficient level value for each sub-mesh.

4. The mesh decoding device according to claim 3, wherein
the arithmetic decoding initialization unit is configured to omit initialization of the context value for syntax that bypasses updating of the context value.

5. A mesh decoding method, comprising:
a step of decoding a displacement bit stream to generate and output a displacement, wherein
the step includes:
a step A of generating a coefficient level value by performing arithmetic decoding on the displacement bit stream;
a step B of updating a context value using the coefficient level value;
a step C of acquiring and accumulating the context value;
a step D of initializing the context value for each frame;
a step E of generating a transform coefficient by performing inverse quantization on the coefficient level value; and
a step F of generating a decoded displacement by performing the inverse transform on the transform coefficient.

6. A non-transitory computer-readable medium having stored thereon a program that is executable by a computer to cause the computer to function as a mesh decoding device, the mesh decoding device including a displacement decoding unit configured to decode a displacement bit stream to generate and output a displacement, wherein
the displacement decoding unit comprises:
an arithmetic decoding unit configured to generate a coefficient level value by performing arithmetic decoding on the displacement bit stream;
a context value update unit configured to update a context value using the coefficient level value;
a context value buffer configured to acquire and accumulate the context value;
an arithmetic decoding initialization unit configured to initialize the context value for each frame;
an inverse quantization unit configured to generate a transform coefficient by performing inverse quantization on the coefficient level value; and
an inverse transform unit configured to generate a decoded displacement by performing inverse transform on the transform coefficient.
